(19) United States
(12) Patent Application Publication
(10) Pub. No.: US 2014/0339823 A1
(43) Pub. Date: Nov. 20, 2014

(54) BEVELED INSERT FOR FACILITATING COUPLING PIPES

(71) Applicant: INFRA-TECT, LLC, Chandler, AZ (US)

(72) Inventor: Steven Karl Wolff, Gilbert, AZ (US)

(73) Assignee: INFRA-TECT, LLC, Chandler, AZ (US)

(21) Appl. No.: 14/280,391

(22) Filed: May 16, 2014

Related U.S. Application Data
(60) Provisional application No. 61/824,074, filed on May 16, 2013.

(51) Int. Cl. F16L 37/26

(52) U.S. Cl. CPC F16L 37/26
USPC 285/339

(57) ABSTRACT

Embodiments of the invention provide an annular pipe insert and pipe assembly system that includes a first pipe segment having a cut end with a face end coupled to a second pipe segment with an insert. The insert includes an annular main body portion including a rear surface and an opposed front surface extending from an inner diameter of the insert. The front surface can include a beveled portion coupled to a top surface portion that extends from the inner diameter of the insert to the beveled portion. The assembly system also includes an inner flange portion coupled to the front surface and extending away from the beveled portion, and an outer flange portion coupled to the inner flange portion. The cut end is inserted into the second pipe segment whereby the face end of the first pipe segment is coupled to the rear surface of the main body portion.

### CROSS REFERENCE TO RELATED APPLICATIONS

This application claims the benefit of filing date of U.S. Provisional Application Ser. No. 61/824,074 titled “BEVELED INSERT FOR FACILITATING COUPLING PIPES”, the specification of which is incorporated by reference herein in its entirety.

### BACKGROUND

Typically, water mains employ a type of pipe known as ductile iron. Lengths of pipe are coupled by inserting the end of one pipe into a belled end of an adjacent pipe. When a non-uniform length of pipe is required, a portion of a pipe segment must be removed by cutting, resulting in a cut end. After the cutting operation, a pipe segment having a belled end receives the cut end of a pipe segment.

Conventionally, when inserting the cut end into the belled end, damage will often occur to an annular gasket. To prevent damage to the annular gasket by the cut end, the cut end is beveled using a saw or grinding device. This is time consuming and can be very dangerous. Additionally, the use of a cut-off saw for this purpose is prohibited by OSHA. Thus, there exists a need to facilitate pipe couplings with a beveled interface at the cut end that negates the need to modify the pipe segment.

### SUMMARY

Some embodiments of the invention include an annular pipe insert and pipe assembly system defining a flow passage that comprises a first pipe segment having a cut end comprising a face end, a second pipe segment having a belled end forming an inner region expanded radially outwardly to terminate in an opening, and including a plurality of grooves forming at least one ridge. The annular pipe insert and pipe assembly system includes a plurality of grooves comprising a first groove proximal to the opening, and a second groove positioned adjacent to the first groove. Further, the second groove is distal to the opening so that the first groove is positioned between the opening and the second groove forming a ridge that at least partially extends into the inner region. The annular pipe insert and pipe assembly system also includes an annular gasket positioned within the inner region adjacent the second groove, and includes a flange portion extending into the first groove, and a coupled portion extending into the opening that is coupled to the flange portion by a sloped portion. The annular pipe insert and pipe assembly system also includes an insert positioned within the first pipe segment and the second pipe segment that comprises an annular main body portion including a substantially flat rear surface, and an opposed front surface extending from an inner diameter of the insert. The front surface comprises a circumferentially beveled portion coupled to a substantially flat top surface portion that extends from the inner diameter of the insert to the beveled portion. The annular pipe insert and pipe assembly system also includes an inner flange portion coupled to the front surface and extending away from the beveled portion, and an outer flange portion coupled to the inner flange portion and extending away from the inner flange portion to an outer diameter of the insert. The cut end of the first pipe segment is inserted into the inner region of the second pipe segment so that the face end of the first pipe segment is received and at least partially coupled to the rear surface of the main body portion.

In some embodiments of the annular pipe insert and pipe assembly system, the coupled portion is substantially perpendicular to the flange portion. In some further embodiments, the insert is held in the inner region by the inner flange portion positioned against the sloped portion, and by the outer flange portion received within the first groove. In some embodiments, the beveled portion is coupled to the sloped portion, and the outer flange portion is positioned at least partially within the first groove coupled to the portion of the gasket and the belled end of the second pipe portion, and the front surface is positioned adjacent to the gasket. In some embodiments, moving the cut end of the first pipe segment into the inner region of the second pipe segment, and engaging the face end of the first pipe segment with the flat surface of the main body portion further includes sliding the cut end past the annular gasket to seat in the belled end.

In some embodiments, the outer flange portion is substantially perpendicular to the inner flange portion. In some further embodiments, the inner flange portion and the main body portion are integrally formed. In other embodiments, the outer flange portion and the inner flange portion are integrally formed.

Some embodiments of the invention comprise a belled end that includes at least one landing. In some embodiments, at least the cut end of the first pipe segment is coupled with the at least one landing. Further, in some embodiments, the insert further includes a substantially circumferential notch extending through a portion of the rear surface and a portion of the inner surface. In some embodiments, the notch comprises a first surface extending from the inner surface and a second surface extending from the rear surface and coupling with the first surface.

In some embodiments, the insert comprises a polymer. Some embodiments include an insert that comprises a least one of a high density polyethylene, polyurethane, polypropylene, polyvinyl chloride, polystyrene, acrylonitrile butadiene styrene, polyamide resin, nylon 6, nylon 66, nylon 11, or nylon 12. Other embodiments include an insert that comprises a biodegradable material. In some embodiments, the biodegradable material comprises at least one of a starch-based polymer, a starch/polyvinylalcohol blend polymer, a polyhydroxybutyrate polymer, a polyhydroxyvalerate polymer, a polyhydroxybutyrate/polyhydroxyvalerate polymer, a polyvinyl lactate polymer, a polylactic acid-based polymer, a polyhydroxyalkanoate-based polymer, a nitrocellulose/wax blend, a poly(ethylene glycol) methyl ether-block-poly(D,L lactide), or a polycaprolactone-block-polytetrahydrofuran-block-polycaprolactone polymer. In some embodiments, at least a portion of the insert is configured and arranged to vacate from the inner region during a period of time after the first pipe segment and second pipe segment are coupled.

In some embodiments, at least one of the outer flange portion or the inner flange portion are bendable and flexible with respect to the front surface. In some embodiments, the inner flange portion extends radially outwardly around the periphery of main body portion and forms an angle between the rear surface of between about 45° and about 50°. In some other embodiments, the inner flange portion extends radially outwardly around the periphery of main body portion and forms an angle between the rear surface of between about 0° and about 45°.

Some embodiments include an insert for coupling pipe segments comprising an annular main body portion including a substantially flat rear surface and an opposed front surface extending from an inner diameter of the insert. The front surface comprises a circumferentially beveled portion coupled to a substantially flat top surface portion that extends from the inner diameter of the insert to the beveled portion. The insert includes an inner flange portion coupled to the front surface and extending away from the beveled portion, and an outer flange portion coupled to the inner flange portion and extending away from the inner flange portion to an outer diameter of the insert.

In some embodiments, the outer flange portion is substantially perpendicular to the inner flange portion. In some further embodiments, the inner flange portion and the main body portion are integrally formed. Some embodiments of the insert further comprise a substantially circumferential notch extending through a portion of the rear surface and a portion of the inner surface. In some embodiments, the notch comprises a first surface extending from the inner surface and a second surface extending from the rear surface and coupled with the first surface.

### DESCRIPTION OF THE DRAWINGS

FIG. 1 is a perspective view of the pipe insert in accordance with one embodiment of the invention.

FIG. 2 is a perspective view of the pipe insert in accordance with one embodiment of the invention.

FIG. 3 is a side view of the pipe insert in accordance with one embodiment of the invention.

FIG. 4 is a sectional view of the pipe insert of FIG. 1 in accordance with one embodiment of the invention.

FIG. 5A is an enlarged partial sectional view of the pipe insert of FIG. 1 in accordance with one embodiment of the invention.

FIGS. 5B-5D show enlarged partial sectional views of a pipe insert in accordance with some embodiments of the invention.

FIG. 6 is a perspective view of the bell end of a pipe illustrating an initial step in an installation operation of the pipe insert in accordance with at least one embodiment of the invention.

FIG. 7 is a sectional view of the bell end of the pipe illustrating the inner gasket and the relative positioning of the pipe insert in accordance with at least one embodiment of the invention.

FIG. 8A is a sectional view of the bell end of the pipe with the pipe insert inserted and a plain end of a mating pipe in a pre-insert position in accordance with one embodiment of the invention.

FIG. 8B illustrates a sectional view of the bell end of a pipe with a pipe insert inserted and a plain end of a mating pipe in a pre-insert position in accordance with another embodiment of the invention.

FIG. 9 is an enlarged sectional view of the bell end of the pipe with the pipe insert inserted, portions thereof broken away in accordance with one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

This invention relates to construction materials. More particularly, the present invention relates to pipe couplings. In a further and more specific aspect, some embodiments of the invention concern devices for facilitating the coupling of pipes such as two separate pipes and/or two portions or segments of a cut pipe. Some embodiments include a system and method for facilitating coupling pipes including having a pipe cut end carrying a beveled attachment or insert. In some embodiments, by masking the sharp edges of the cut end of a pipe with the beveled attachment, the pipe can be inserted into the belled end through the annular gasket without any damage occurring thereto. In some embodiments, the belled end is of conventional manufacture and includes an annular gasket carried therein. As used herein, the term “belled” is used to describe any pipe end that acts as a female fitting and is configured to receive another pipe end, and is intended to include pipes having at least a portion with a larger diameter than the inserted pipe.

Turning now to the drawings in which like reference characters indicate corresponding elements throughout the several views, attention is first directed to FIGS. 1-4, which illustrate a pipe insert 10, in accordance with some embodiments of the invention. As will be appreciated by those skilled in the art, pipe insert 10 is intended to facilitate the insertion of a pipe end into a receiving pipe end and/or pipe fitting. It will be understood by those skilled in the art that pipe insert 10 can be used to couple a pipe to another pipe or to a pipe fitting. The term “pipe” as used in the following description and claims is intended to include both a pipe and a pipe fitting, and can include two pipes that have not been formed from the same length of pipe, or can include a two pipes that originated from the same pipe where the pipe was cut or segmented to form two or more pipe portions or segments. The pipe can be constructed of virtually any material, and can be employed to carry substantially any material. For the purposes of the present description however, the pipe to be joined is preferably of the type referred to as ductile iron, and used primarily for water mains. It will also be understood that the present invention may be employed with substantially any diameter pipe.

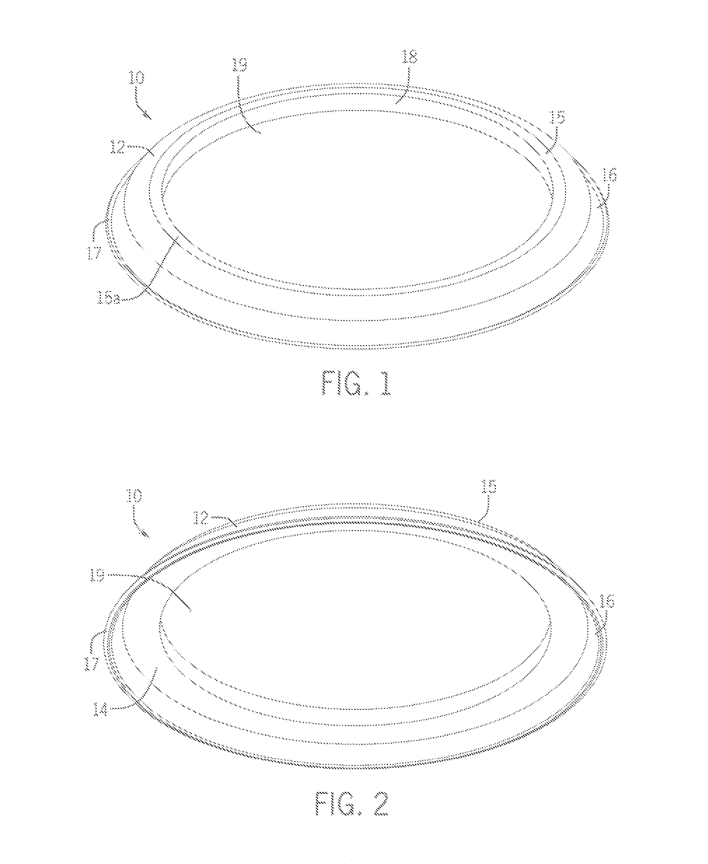

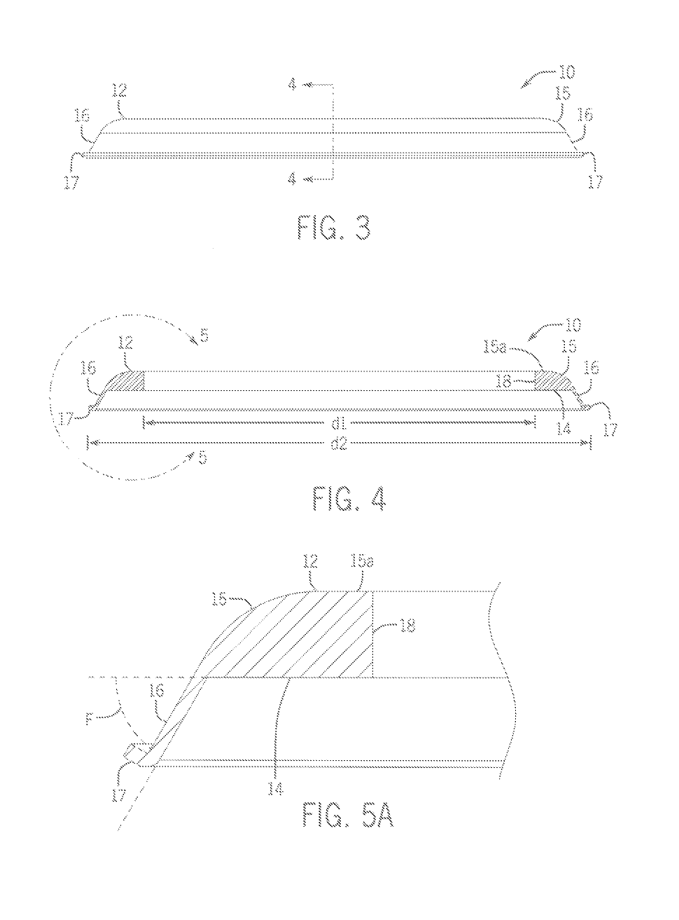

FIGS. 1 and 2 show perspective views of the pipe insert 10 with views from a generally top and a generally rear perspective respectively. FIG. 3 is a side view of the pipe insert 10 in accordance with one embodiment of the invention, and FIG. 4 is a sectional view of the pipe insert 10 of FIG. 1 through the cut-line marked 4 in FIG. 3 in accordance with one embodiment of the invention. As illustrated, in some embodiments, the pipe insert 10 is ring-shaped or substantially annular in shape, and includes a main body portion 12 forming an aperture 19. In some embodiments, the main body portion 12 can include a rear surface 14, and a coupled front surface 15. In some embodiments, the rear surface 14 is substantially flat and extends from the inner diameter d1 of the pipe insert 10 to an inner flange portion 16. In some embodiments, the front surface 15 can include a substantially rounded or beveled portion 15b, and a top surface portion 15a. In some embodiments, the top surface portion 15a is substantially flat and extends from the beveled portion 15b to the inner diameter d1 of the pipe insert 10. Further, in some embodiments, the rear surface 14 and the top surface portion 15a are substantially parallel. For purposes of orientation, the terms “forward” and “forwardly” define a direction from rear surface 14 toward front surface 15, and the terms “rearward” and “rearwardly” define a direction from front surface 15 toward rear surface 14.

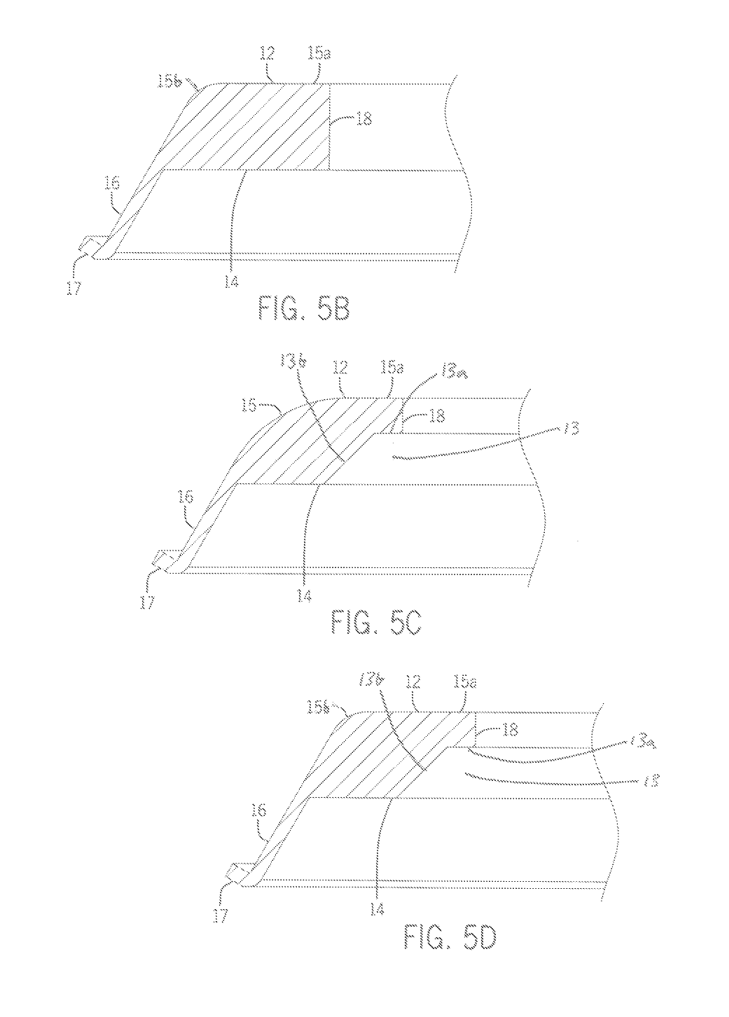

In some embodiments, the pipe insert 10 can include an inner flange portion 16 that can extend radially outwardly around the periphery of main body portion 12, and directed rearwardly past rear surface 14 (e.g., see in particular FIGS. 4 and 5). As illustrated, in some embodiments, the inner flange portion 16 can extend radially outwardly around the periphery of main body portion 12 forming an angle F between the rear surface 14. In some embodiments, the angle is less than about 90°. For example, in some embodiments, the inner flange portion 16 can extend radially outwardly around the periphery of main body portion 12 to form an angle F between the rear surface 14 that is about 50°. In some other embodiments, the inner flange portion 16 can extend radially outwardly around the periphery of main body portion 12 to form an angle F between the rear surface 14 that is at an angle between about 45° and an angle of about 50°. In some other embodiments, the inner flange portion 16 that can extend radially outwardly around the periphery of main body portion 12 to form an angle F that is greater than 0° and less than about 45°.

In some embodiments, the inner flange portion 16 can be integrally formed with main body portion 12 (e.g. the main body portion 12 and the inner flange portion 16 comprise a monolithic body forming the pipe insert 10). In some other embodiments, the inner flange portion 16 can be coupled to the main body portion 12. For example, in some embodiments, the inner flange portion 16 can comprise a discrete structure that is coupled to the main body portion 12, for example by pressure fitting, welding, soldering, with an adhesive, or a combination thereof.

In some embodiments, at least some portion of the pipe insert 10 can be constructed of a polymer. For example, in some embodiments, the polymer can comprise high density polyethylene, polyurethane, polypropylene, polyvinyl chloride, polystyrene, acrylonitrile butadiene styrene, polyamide resin, nylon 6, nylon 66, nylon 11, nylon 12 or other types of nylon, combinations thereof (e.g., including discontinuous or continuous composites or polymer blends), or other types of polymeric materials that are capable of providing the desired physical, chemical, and mechanical characteristics. However, as will be understood by those skilled in the art, other materials such as metal, resins, composites, etc. may be employed. For example, in some embodiments, at least some portion of the pipe insert 10 can comprise a conducting material such as a metal that includes an electrically insulating coating and/or layer. For example, in some embodiments, the pipe insert 10 can comprise a metal such as iron, steel, aluminum, brass, or other metal that is coated with a polymer layer including any one or mixture of the polymers described previously.

In some embodiments, by providing an insert 10 comprising a material that is electrically (e.g., which is the case for many polymers), pipe segments joined using the pipe insert 10 can be substantially electrically disconnected, reducing or eliminating conductivity between the pipe segments and thereby can inhibit stray current corrosion. For example, in some embodiments, when the pipe insert 10 is substantially electrically insulating by virtue of being fabricated of one or more polymers, or including a polymer coating, first and second pipe segments 22a, 22b can be electrical isolated from each other when coupled using the pipe insert 10. Alternatively, in some embodiments, conductive threads or contacts can be added to the pipe insert 10 to promote and enhance conductivity between pipe segments (such as first and second pipe segments 22a, 22b). Continuous conduction along a pipe line can be useful in certain applications, such as systems which utilize cathodic corrosion protection.

In some embodiments, the pipe insert 10 can disappear (i.e. vacate from the pipe insert 10) over a period of time after the pipe insert 10 has been inserted. For example, in some embodiments, the pipe insert 10 can dissolve and/or degrade over a period of time after the pipe insert 10 has been inserted to couple the first and second pipe segments 22a, 22b. In some embodiments, at least a portion of the pipe insert 10 can comprise a dissolvable and/or biodegradable material. For example, in some embodiments, the pipe insert 10 can comprise a starch-based polymer, such as a starch/polyvinylalcohol blend polymer. Other biodegradable polymers that can be used include polyhydroxybutyrate and/or polyhydroxybutyrate/polyhydroxyvalerate copolymers or blends, polyvinyl lactate, polylactic acid-based polymers, polyhydroxyalkanoate-based polymers nitrocellulose/wax blends, biodegradable AB diblock copolymers such as Poly(ethylene glycol) methyl ether-block-poly(D,L lactide), biodegradable AB triblock copolymers such as polycaprolactone-block-polytetrahydrofuran-block-polycaprolactone, or combinations, blends, and/or copolymers thereof. In some embodiments, the main body portion 12 and the inner flange portion 16 can comprise a material that is substantially the same. In some embodiments, the pipe insert 10 can comprises a substantially homogeneous composition that can comprise any one of the materials described herein. In some other embodiments, the main body portion 12 and the inner flange portion 16 can comprise different materials and/or a heterogeneous mixture of any of the materials described herein.

In some embodiments, the pipe insert 10 can include additional flange structures. Some embodiments of the invention include a pipe insert 10 that can include or be coupled to an outer flange portion 17. For example, some embodiments of the invention include an outer flange portion 17 that can extend from the inner flange portion 16. In some embodiments, the pipe insert 10 can include an outer flange portion 17 that can extend radially outwardly from the inner flange portion 16 to the outer diameter d2 of the pipe insert 10. In some embodiments, the outer flange portion 17 can extend substantially perpendicularly from the inner flange portion 16. In some other embodiments, the outer flange portion 17 can extend from the inner flange portion 16 at an angle that is greater than 90°. For example, in some embodiments, the outer flange portion 17 can extend radially outwardly from the periphery of inner flange portion 16 and can be substantially parallel to rear surface 14. In other embodiments, the outer flange portion 17 can extend from the inner flange portion 16 at an angle that is less than 90°. In some embodiments, the outer flange portion 17 can extend a distance of substantially 1/64^{th} inch from the inner flange portion 16. In some other embodiments, the outer flange portion 17 can extend a distance less than or greater than about 1/64^{th} inch from the inner flange portion 16.

In some embodiments, the main body portion 12 and the outer flange portion 17 can comprise a material that is substantially the same. In some other embodiments, the main body portion 12 and the outer flange portion 17 can comprise different materials. Further, in some embodiments, the inner flange portion 16 and the outer flange portion 17 can comprise a material that is substantially the same. In some other embodiments, the inner flange portion 16 and the outer flange portion 17 can comprise different materials.

In some embodiments, the inner flange portion 16 can be approximately ¼^{th} of an inch in width. Further, in some embodiments, the outer flange portion 17 can be approximately 1/16^{th} of an inch in width. In some other embodiments, the inner flange portion 16 and/or the outer flange portion 17 can include other proportions. For example, in some embodiments, the inner flange portion 16 can be greater than or less than about ¼^{th} of an inch in width. In some other embodiments, the outer flange portion 17 can be greater than or less than about 1/16^{th} of an inch in width.

Some embodiments of the invention can include a pipe insert 10 that can comprise at least one bendable or flexible portion. As shown in FIG. 4, and in detail in FIG. 5A showing an enlarged partial sectional view of the pipe insert of FIG. 1 (with FIG. 4 illustrating the region illustrated marked as 5), in some embodiments, the pipe insert 10 can include at least an inner flange portion 16 that is flexible or bendable. Further, in some embodiments, the pipe insert 10 can include at least an outer flange portion 17 that is flexible or bendable. In some embodiments, the main body portion 12 of pipe insert 10 has an inner diameter (e.g., circumferentially enclosing the aperture 19) that is approximately equal to the inner diameter of the cut end 40 of a first pipe segment 22a. Further, in some embodiments, the main body portion 12 of the pipe insert 10 can include an outer diameter substantially equal to the outer diameter of the cut end of the first pipe segment 22a. As discussed earlier, in some embodiments, the rear surface 14 of main body portion 12 is substantially flat, and in some embodiments, the substantially flat rear surface 14 of main body portion 12 can couple with the flat cut end 40a of the pipe segment 22a, as will be described in more detail below. Further, in some embodiments, the front surface 15 includes a slope that may be of any pitch so as to efficiently couple with the annular gasket 28 in a belled end 20 of the second pipe segment 22b. Moreover, in some embodiments, the front surface 15 can be a rounded chamfer or other configuration. Throughout this disclosure the term “beveled” is used as a generic term to denote front surface 15. In some embodiments, the front surface 15 can comprise a curvature that is different from that depicted in FIG. 4. For example, in some embodiments, the curvature of the front surface 15 can be greater or smaller than that shown in FIG. 4. In some other embodiments, the curvature may vary across the front surface 15. For example, some embodiments of the front surface 15 can comprise a front surface 15b as shown in FIGS. 5B and 5D.

In some further embodiments, the pipe insert 10 can include one or more structures configured to ease insertion of the first pipe segment 22a and/or couple with and/or guide the cut end 40 of the pipe segment during insertion into the second pipe segment 22b. For example, as shown in FIGS. 5C and 5D, in some embodiments, the main body portion 12 can include a notch 13. As shown, in some embodiments, the notch 13 can extend through a portion of the rear surface 14 and a portion of the inner surface 18. In some embodiments, the notch 13 can extend into the main body portion 12, and can comprise a first surface 13a extending from the inner surface 18, and a second surface 13b extending from the rear surface 14, and coupling with the first surface 13a. In some embodiments, the first surface 13a can be substantially parallel with the rear surface and/or the top surface portion 15a. Further, some embodiments include a second surface 13b that is substantially parallel with the inner surface 18. In other embodiments, the second surface 13b can be substantially parallel with the inner flange 16, or can extend from the first surface 13a are greater or lesser angles than those defined by being positioned substantially parallel to either of the inner surface 18 and the inner flange 16.

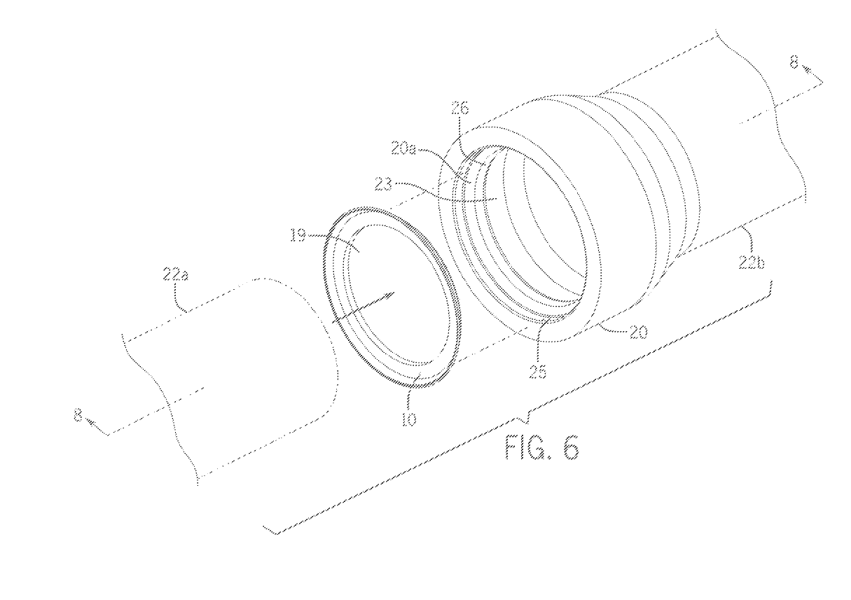

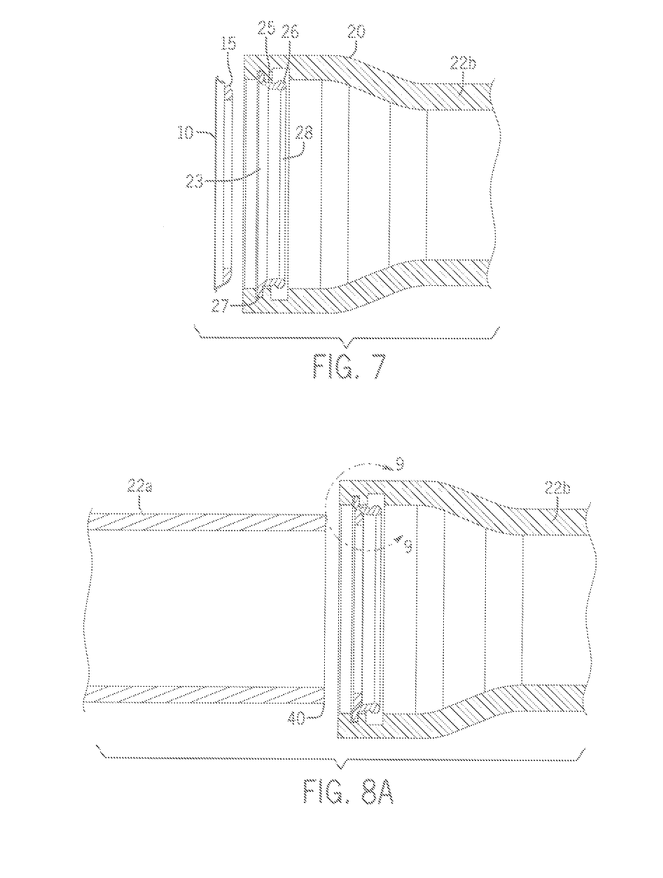

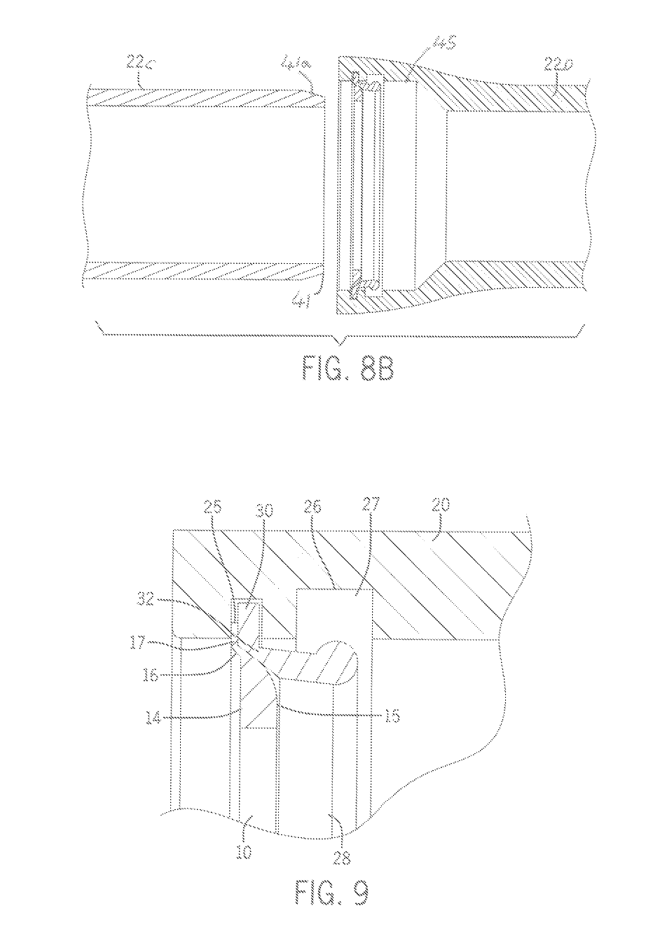

In some embodiments, the annular insert can define a flow region by coupling pipes to form a fluid conduit. Further, some embodiments of the invention can include an installation method using pipe insert 10 for coupling pipes. Turning now to FIGS. 6, and 8A-8B, some embodiments can include an initial step in an installation process as illustrated. In some embodiments, the annular insert can be used to couple at least two pipe segments comprising a first pipe segment 22a including a cut end 40 to a second pipe segment 22b comprising a belled end 20 defining an opening 23. For convenience in understanding, a second pipe segment 22b with a belled end 20 of conventional manufacture is illustrated and described. Further, the belled end 20 of second pipe segment 22b can define an opening 23. In some embodiments, the belled end 20 of pipe 22 can be constructed with a pair of grooves 25 and 26 formed in the inner region 20a of the belled end 20. In some embodiments, one or each of grooves 25, 26 can extend completely around the circumference of the second pipe segment 22b. In some embodiments, the groove 25 is formed adjacent (proximal) to the opening 23, and groove 26 is formed adjacent groove 25 (distal to the opening so that the groove 25 is positioned between the opening 23 and the groove 26) so as to define a ridge 27 therebetween (best seen in FIG. 9), at least partially extending into the inner region 20a. In some embodiments, an annular gasket 28 is initially installed with an outwardly extending flange 30 positioned in groove 25, and a portion 32 extending into opening 23. In some embodiments, portion 32 is substantially perpendicular to, and coupled to flange 30 by a sloped portion 34. As explained above, the purpose of annular gasket 28 is to provide a seal between the inner surface of belled end 20 and the outer surface of a mating pipe end (face end 40a).

As illustrated in FIG. 9, some embodiments include an initial step in the installation of the pipe insert 10 where the front surface 15 can be positioned to face the opening 23 of belled end 20 with the flat rear surface 14 facing away from opening 23. In some embodiments, the pipe insert 10 can be moved into opening 23 until the inner flange portion 16 is positioned overlying and/or coupled to the sloped portion 34, and the outer flange portion 17 is received in groove 25. In some embodiments, the main body portion 12 can extend into the opening 23 in front of annular gasket 28. In some embodiments, the inner flange portion 16 of the pipe insert 10 can include a length that allows it to substantially overlie the sloped portion 34, and the outer flange portion 17 can be easily positioned in groove 25 along with the flange 30 of annular gasket 28. As illustrated, in some embodiments, the outer flange portion 17 can be coupled to the groove 25 in the second pipe segment 22b and the flange 30 of the annular gasket 28.

Further, in some embodiments, the outer diameter of inner flange portion 16 can be substantially the same as the inner diameter of belled end 20. Further, the outer diameter of outer flange portion 17 can be only slightly smaller than the diameter of groove 25 so that outer flange portion 17 extends well into groove 25. For example, in some embodiments, the outer flange portion 17 and the groove 25 can be sized so that the outer flange portion 17 extends approximately half-way into the groove 25 (as depicted in FIG. 9). In some other embodiments, the groove 25 and/or the outer flange portion 17 can be sized so that the outer flange portion 17 extends substantially the entire depth of the groove 25. In other embodiments, the groove 25 and/or the outer flange portion 17 can be sized so that the outer flange portion 17 extends into the groove 25 so that the outer edge of the outer flange portion 17 is immediately adjacent to the inner edge of the groove 25 (i.e., the outer diameter of the outer flange portion 17 is only slightly larger than the inner diameter of the belled end 20).

Here it will be understood by those skilled in the art that groove 25 of conventional manufactured belled ends is generally wide enough to receive the flange of the annular gasket 28 and the outer flange portion 17 of the pipe insert 10 without requiring any additional removal of material or other work. Thus, in some embodiments, the pipe insert 10 can be held in opening 23 within the inner region 20a by inner flange portion 16 residing against sloped portion 34, and by the outer flange portion 17 received within groove 25. In this instance, the substantially flat rear surface 14 can be positioned facing outwardly in opening 23, and the front surface 15 can be adjacent annular gasket 28.

Referring additionally to FIG. 8A, in some embodiments, to insert a cut end 40 of a first pipe segment 22a into belled end 20 of a second pipe segment 22b, cut end 40 is initially axially aligned with belled end 20 prior to insertion into the belled end 20 of the pipe segment 22b. While cut end 40 is used in the description, it will be understood that the term “cut end” can include cut ends, broken ends, chiseled ends, jagged ends, and manufactured ends that are to be received by belled end 20. In some embodiments, the cut end 40 is moved axially into the belled end 20 so that the end surface 40a first engages the flat rear surface 14 of pipe insert 10. In some embodiments, an installer can continue to move the cut end 40 axially into the belled end 20. In some embodiments, this can cause the outer flange portion 17 to pull out of groove 25, and wrap around the outer edge with front surface 15 simultaneously pushing against annular gasket 28. Thus, in some embodiments, the pipe insert 10 can completely cover the cut end 40, allowing it to slide past the annular gasket 28, and to seat in the belled end 20. In this instance, the sharp edges of cut end 40 are masked during insertion of the first pipe segment 22a into belled end 20 of second pipe segment 22b. Moreover, the annular gasket 28 can remain substantially undamaged, and can effectively engage and seal to the second pipe segment 22b as pipe insert 10 passes completely through the annular gasket 28. It should be noted that in some embodiments, the pipe insert 10 passes completely through gasket 28 during insertion. Further, in some embodiments, once cut end 40 is completely installed (i.e., the pipe segment 22a has been pushed into its home position), the pipe insert 10 can remain substantially in place over the cut end 40.

Some embodiments of the invention include pipe segments that include variations in size, profile, and cut. For example, in some embodiments, the cut end 40 and the belled end 20 can include other shapes and profiles than those described and shown for example in FIG. 8A. In some embodiments, the first pipe segment 22a can comprise a machine cut pipe that can include a cut end with a different shape and profile. Further, in some embodiments, some pipe segments can comprise a shape and profile of a belled end that is different from that in the example of the belled end 20. For example, as shown in FIG. 8B, in some embodiments, the first pipe segment 22a can comprise a pipe segment 22c that includes a cut end 41 with an end surface 41a that includes a different shape and profile that the cut end 40 shown in FIG. 8A. Further, in some embodiments, the second pipe segment 22b can comprise a pipe segment 22d that can comprise a different shape and profile. Moreover, in some embodiments, the pipe segment 22d can comprise one or more features that can assist an installer position and seat the pipe segment 22c. For example, in some embodiments, the pipe segment 22d can comprise one or more landings 45 positioned within the inner region 20a. In some embodiments, the landings 45 can facilitate receiving and positioning the pipe segment 22c as the pipe segment 22c is passed into the pipe segment 22d, and into the pipe insert 10 and the gasket 28. For example, in some embodiments, moving the pipe segment 22c into the inner region 20a of the pipe segment 22d and engaging the face end 40, 41 of the pipe segment 22c with the flat rear surface 14 of the main body portion 12 further includes sliding the cut end 40, 41 past the annular gasket 28 and to seat in belled end 20. In this instance, the cut end 40, 41 can be coupled with the landing 45.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. Various changes and modifications to the embodiments herein chosen for purposes of illustration will readily occur to those skilled in the art. To the extent that such modifications and variations do not depart from the spirit of the invention, they are intended to be included within the scope thereof. The entire disclosure of each patent and publication cited herein is incorporated by reference, as if each such patent or publication were individually incorporated by reference herein. Various features and advantages of the invention are set forth in the following claims.

1. An annular pipe insert and pipe assembly system defining a flow passage, the assembly comprising;
a first pipe segment having a cut end comprising a face end;
a second pipe segment having a belled end, the belled end forming an inner region expanded substantially radially outwardly to terminate in an opening and including a plurality of grooves forming at least one ridge,
the plurality of grooves comprising a first groove proximal to the opening and a second groove positioned adjacent to the first groove,
the second groove distal to the opening so that the first groove is positioned between the opening and the second groove forming a ridge,
the ridge at least partially extending into the inner region;
an annular gasket positioned within the inner region adjacent the second groove and including a flange portion extending into the first groove and a coupled portion extending into opening, the coupled portion coupled to the flange portion by a sloped portion;
an insert positioned within the first pipe segment and the second pipe segment, the insert comprising an annular main body portion including a substantially flat rear surface and an opposed front surface extending from an inner diameter of the insert,
the front surface comprising a circumferentially beveled portion coupled to a substantially flat top surface portion, the top surface portion extending from the inner diameter of the insert to the beveled portion; and
an inner flange portion coupled to the front surface and extending away from the beveled portion; and
an outer flange portion coupled to the inner flange portion and extending away from the inner flange portion to an outer diameter of the insert; and
wherein the cut end of the first pipe segment is inserted into the inner region of the second pipe segment so that the face end of the first pipe segment is received and at least partially coupled to the rear surface of the main body portion.

2. The system of claim 1, wherein the coupled portion is substantially perpendicular to the flange portion.

3. The system of claim 2, wherein the insert is held in the inner region by the inner flange portion positioned against the sloped portion and by the outer flange portion received within the first groove.

4. The system of claim 3, wherein the beveled portion is coupled to the sloped portion,
the outer flange portion is positioned at least partially within the first groove coupled to the portion of the gasket and the belled end of the second pipe portion, and
the front surface is positioned adjacent to the gasket.

5. The system of claim 1, wherein moving the cut end of the first pipe segment into the inner region of the second pipe segment and engaging the face end of the first pipe segment with the flat surface of the main body portion further includes sliding the cut end past the annular gasket to seat in the belled end.

6. The system of claim 5, wherein the belled end includes at least one landing.

7. The system of claim 6, wherein at least the cut end of the first pipe segment is coupled with the at least one landing.

8. The system of claim 1, wherein the outer flange portion is substantially perpendicular to the inner flange portion.

9. The system of claim 1, wherein the inner flange portion and the main body portion are integrally formed.

10. The system of claim 1, wherein the outer flange portion and the inner flange portion are integrally formed.

11. The system of claim 1, wherein the insert further includes a substantially circumferential notch extending through a portion of the rear surface and a portion of the inner surface.

12. The system of claim 11, wherein the notch comprises a first surface extending from the inner surface and a second surface extending from the rear surface and coupled with the first surface.

13. The system of claim 1, wherein the insert comprises a polymer.

14. The system of claim 13, wherein the polymer comprises at least one of a high density polyethylene, polyurethane, polypropylene, polyvinyl chloride, polystyrene, acrylonitrile butadiene styrene, polyamide resin, nylon 6, nylon 66, nylon 11, or nylon 12.

15. The system of claim 1, wherein the insert comprises a biodegradable material.

16. The system of claim 15, wherein the biodegradable material comprises at least one of a starch-based polymer, a starch/polyvinylalcohol blend polymer, a polyhydroxybutyrate polymer, a polyhydroxyvalerate polymer, a polyhydroxybutyrate/polyhydroxyvalerate polymer, a polyvinyl lactate polymer, a polylactic acid-based polymer, a polyhydroxyalkanoate-based polymer, a nitrocellulose/wax blend, a poly(ethylene glycol) methyl ether-block-poly(D,L lactide), or a polycaprolactone-block-polytetrahydrofuran-block-polycaprolactone polymer.

17. The system of claim 1, wherein at least a portion of the insert is configured and arranged to vacate from the inner region during a period of time after the first pipe segment and second pipe segment are coupled.

18. The system of claim 1, wherein at least one of the outer flange portion or the inner flange portion are bendable and flexible with respect to the front surface.

19. The system of claim 1, wherein the inner flange portion extends radially outwardly around the periphery of main body portion and forms an angle between the rear surface of between about 45° and about 50°.

20. The system of claim 1, wherein the inner flange portion extends radially outwardly around the periphery of main body portion and forms an angle between the rear surface of between about 0° and about 45°.

21. An insert for coupling pipe segments comprising:
an annular main body portion including a substantially flat rear surface and an opposed front surface extending from an inner diameter of the insert,
the front surface comprising a circumferentially beveled portion coupled to a substantially flat top surface portion, the top surface portion extending from the inner diameter of the insert to the beveled portion; and
an inner flange portion coupled to the front surface and extending away from the beveled portion; and
an outer flange portion coupled to the inner flange portion and extending away from the inner flange portion to an outer diameter of the insert

22. The insert of claim 21, wherein the outer flange portion is substantially perpendicular to the inner flange portion.

23. The insert of claim 21, wherein the inner flange portion and the main body portion are integrally formed.

24. The insert of claim 21, further comprising a substantially circumferential notch extending through a portion of the rear surface and a portion of the inner surface.

25. The insert of claim 24, wherein the notch comprises a first surface extending from the inner surface and a second surface extending from the rear surface and coupled with the first surface.
